(19) United States
(12) Patent Application Publication
(10) Pub. No.: US 2015/0119124 A1
(43) Pub. Date: Apr. 30, 2015

(54) Contract the game of the century

(71) Applicant: Noble Laird, Center Moriches, NY (US)

(72) Inventor: Noble Laird, Center Moriches, NY (US)

(21) Appl. No.: 13/998,377

(22) Filed: Oct. 28, 2013

(51) Int. Cl. G07F 17/32

(52) U.S. Cl. CPC G07F 17/3286
USPC 463/17

(57) ABSTRACT

A game supervised by a chief contractor with a programmable remote (FIG. 9) that starts a contract wheel (FIG. 1) spinning around, and time clock allowing 5 seconds to shoot a miniature basketball (FIG. 3) at a basket (FIG. 2) before a buzzer sounds, said Basketball lands on a spinning contract wheel similar to a roulette wheel (FIG. 1) but contains 18 slots; 10, 20, 50 point slots, two each on black and on red, two 100 point slots, one black, one red, two 200 points green bull's-eye, two yellow lose 200 point slots. Scoring determined by number on ball tossed times number it settles on the wheel; black would gain while red would loose point chips, said scoring also determined by wagers made on a wager board (FIG. 6) times the number on the wager chip placed on said wager board. Said is played with 4 teams, each of said teams receiving 3000 chips in a chip sack (FIG. 7) at the beginning of the game, the winning team is the team that has the most point chips (FIG. 4) at the end of four quarters.

### CROSS REFERENCES

Not Applicable;

Roulette is not under patent, so the creation of a new and specific patentable feature for it does not infringe any existing patent, so as long as that new feature is completely and provably unrelated to other proprietary product associated with the game.

### FEDERALLY SPONSORED RESEARCH

None

### SEQUENCE LISTING

None

### BACKGROUND

The game of Roulette is a standard and public domain casino game where players may make wagers on a number, group of numbers such as a row, column, “corner,” “split,” or “street,” or a number characteristic, such as “odd” or “even,” or a “red number” or a “black number.” The mechanism of the number generation in Roulette is determined by spinning a ball in a grooved gutter over a rotating wheel, where the ball later drops into a numbered slot on the wheel to determine the number result. This is the basic form of the game. Contract is obliviously different in many respects, for example wagers are made on a wager board specially designed to look similar to the contract wheel. The ball resembling a basketball has a number 1, 5, 10, or 20 on it's face and is used, along with the wager board, to make wagers, the ball is tossed into a basket netting a score of 200 times the number on the face of the ball tossed on a made shot. No points are lost on a missed shot for the shooter, or the person tossing the ball, however points can still be lost or gained depending on where the tossed ball ultimately lands on the contract wheel. To start the game teams must secure contracts with the contractors. This is accomplished by each of the four teams selecting contract chips from their supply of colored contract chips, 8 of any value each having either a 1, 5, 10, or 20 on the face of the contract chip to be used as wagers. The contract chips are placed on the unique contract wager board which is designed to look like the contract wheel in an attempt aid the players to guess where the tossed ball will land thus netting the winner or loser the number on the face of the ball times the winning number on the wager board. Additionally, other new types of bets can be designed for the game of contract that are not a part of the existing bet structure as defined above. This is the area where this patent pertains, as it not only describes a new and proprietary bet structure for the game of Roulette but includes the new design of the roulette wheel; named the contract wheel, this contract wheel is no ordinary roulette wheel, as the contract wheel has only 18 slots represented as follows 10, 20, and 50 point slots, two of each on black and two of each on red, one each 100 point slots, one on black and one on red. For example the said numbers occupy spaces as such: (2) 10 point slots on black, (2) 20 point slots on black, (2) 50 point slots on black (1) 100 point slot on black, (2) 10 point slots on red, (2) 20 point slots on red, (2) 50 point slots on red, (1) 100 point slot on red, (2) lose 200 point slots which are yellow, and (2) slots for the bull's-eye worth 200 points which are green, for a total of 18 slots. Each slot is fitted with a molded indenture designed to fit the contract ball, once it lands on the contract wheel. The specially designed wager board looks similar to the wheel and contains spaces as such: (2) 10 point spaces on black, (2) 20 point spaces on black, (2) 50 point spaces on black (1) 100 point space on black, (2) 10 point spaces on red, (2) 20 point spaces on red, (2) 50 point spaces on red, (1) 100 point space on red, (2) lose 200 point spaces which are yellow, and (1) space for the bull's-eye worth 200 points which is green and is used solely to wager that the ball will land on that spot, however should you want to wager that the shooter will make or miss the shot you would place your wager on (1) space for the bull's-eye worth 200 points in the middle of the board which is divided in half, one side for a wager that the shooter makes the basket and marked bet here to make bulls eye basket, or the other side is a wager that he misses the said shot, and marked bet here to miss bulls eye basket, for a total of 19 spaces. This game also features shooting baskets with a time clock expiring and a buzzer sounding! More specifically; tossing a miniature basketball with a contracted number on the face into a basket complete with rim, net and a time clock. The chief contractor using the unique contract remote, starts the contract wheel making it spin around, as a time clock begins it's countdown, allowing only 5 seconds to shoot the ball before a buzzer sounds, much like that at a basketball game. Players toss one of their preselected contract balls at the bulls-eye basket. Initially he is filled with jubilation if he made the basket, but then feels only despair if he missed it. But because shooters lose no points on a missed basket he's not too worried. But this session is not over, because the excitement and anticipation continues as the shooter, his teammate and the other team competitors watch to see if the tossed contract ball settles on a black or red slot or on the numbered slot they wagered on the contract wager board. To land on black is always good for the shooter but he loses the number on the face of the tossed ball times the number on the red slot he lands on. However the shooter or any other contestant could deliberately place a bet on a red number and if the ball lands on red and is on the correctly number chosen, it wins the bettor the number on the face of the tossed ball times the number of the red slot landed on. Everyone is set to cheer or groan as the contract wheel slows to a stop to reveal the balls final resting spot as this determines the payouts for the wagers made by the shooter, his teammate and the other game participants, called bettors. Such wagers were made by contestants by placing wager chips with numbers on the face onto the contract wager board in an attempt to anticipate the numbered slot the ball will eventually comes to rest on. A winning wager would net the bettor the number on the wager chip times the number the space wagered on occupies. Another feature of the game is the contract remote. Nothing is more novel or exciting than the contract remote. Because the contract remote can be quickly programmed to have a personality, that way no two games need sound alike. In fact the chief contractor gets to determine the personality that consoles or congratulates the game participants, in any of four different languages, and choosing from one of eight personalities, including maniacal, syfy, gnome, sensual female, valley girl, chipmunk, infant child, and hysterical. The remote is used solely by the chief contractor. The said chief contractor also uses the contract remote to start the time clock, start the contract wheel, activate the flashing strobe lights and ringing bells. When an attempted toss is negative he uses one of his programmed buttons to make an expression of disappointment, or when an attempted toss is successful, he uses one to make an expression of jubilation. The remote also features much more as described under the sub heading “How to operate the contract remote.” The said remote also serves as a calculator to assist in calculation of payouts. Contract, the game of the century lives up to it's name and is guaranteed to grab the attention of your guest and have them transfixed all night.

### BRIEF SUMMARY OF THE INVENTION

Contract-the game of the century is a new and exciting game, combining several features that are appealing to the masses; Contract allows a player to bet that game contestants including his own teammate will make or miss a basket or bet on where his tossed ball will land once it falls on the contract wheel. The 8 players are supervised by two contractors; the chief contractor and his assistant. After teammates selects the 8 balls, and the 8 contract wager chips, said balls and chips are called contracts, because of the numbers on the face and that they must be selected prior to the beginning of play and cannot be reneged but are binding; hence the name of the game, said balls and chips which have either a 1, 5,10 or 20 on the face and are used to make wagers on the play. Said numbers are multiplied by the number the ball lands on the contract wheel for the shooter, but the chips get multiplied by the number on the chip times the number wagered on the wager board. The game ends after four quarters. A quarter is complete once one player for all four teams has tossed a ball at the bulls eye basket. The four teams start the game with equal amounts of chips in their chip sacks. The winning team are the teammates with the most points in chips left in their combined chip sacks at the end of the fourth quarter at which time all players on all teams would have each tossed two balls.

### DETAILED DESCRIPTION OF THE GAME

Contract-the game of the century is played as follows:

Game participants, up to ten, consisting of two contractors; the chief contractor, who handles the contract remote, spins the contract wheel and handles the contracts and payouts for the game contestants when they act as the designated shooter, and the assistant contractor, who handles the contracts and payouts for the game contestants when they act as bettors. The contestant are divided into four teams, consisting of two players per team. Each team is identified by color; red, black, blue or green. The game begins with the chief contractor establishing contracts with the contestants. This is done by the contestants from all four teams choosing from their supply of 16 colored balls, 4 balls of any value ranging from either a 1, 5, 10, or 20 on the face of the ball. Remember, the higher the value, the more potential for gain or loss. A very conservative team could select several 5′s, while a more aggressive team might select several 20′s. While the more middle of the road team may select a mixture perhaps a 1, 5, 20 and a 10 ball, So the teams will choose 4 balls based on what each is willing to risk. The remaining balls remain in the possession of the chief contractor. At the same time, the contestants must follow this same procedure with the assistant contractor, choosing from their supply of 32 colored contract chips, 8 of any value ranging from either a 1, 5, 10, or 20 on the face of the contract chip to be used as wagers. Once all shooters and bettors have established contracts with their contractors then the contestants place their bets. After the chief contractor says all bets are closed, those placing wagers are to step away from the betting area and play begins. The order of play is always red, black, blue and green to begin each quarter. Therefore Someone from the red team begins play and this would be the first session, the red session. This same player would also shoot the third quarter, while his partner would be the shooter for the second and fourth quarters. When one member from all four teams have tossed their first ball and all contestants have placed their wager for each toss, and the contractors have paid all winning wagers and gotten paid for all loss wagers, and cleared all chips from the wager board, then the first quarter is complete.

Each teammate alternates as the designated shooter for his or her team per designated session. Each of the players must make a wager at each and every session of play. A session begins with the toss of a ball from a team represented by color, and ends with the payout of wagers and clearing the wager board of chips. The first session would belong to the red team since they are designated to go first, while the second session would belong to the black team, the third session belongs to the blue team and the fourth session which completes a quarter belongs to the green team. The first session beginning the second quarter would belong to the red team, again, since they are designated to go first, the alternate team mate now gets to be the shooter on all four of the teams. The second session of the second quarter would belong to the black team, the third session belongs to the blue team and the fourth session which would complete the second quarter belongs to the green team. At this point we are at the half and new contracts must be established the same as at the start of the game. At his discretion the chief contractor he may offer his assistance to the assistant contractor if play begins to lag at payout. Otherwise he can use this time to make cleaver remarks with the contract remote thus keeping the crowd entertained. Not to be redundant but each time a different person shoots a ball marks the beginning of a session and that session ends once the wagers have been paid and the wheel and wager boards have been cleared by the contractors. There are four sessions to a quarter, and four quarters to a complete game.

For example:
Session 1: Red #1 tosses Red team's 1st. ball.
All contestants including Red #1 place a wager.
Session 2: Black #1 tosses Black team's 1st. ball.
All contestants including Black #1 place a wager.
Session 3: Blue #1 tosses Blue team's 1st. ball.
All contestants including Blue #1 place a wager.
Session 4: Green #1 tosses Green team's 1st. ball.
All contestants including Green #1 place a wager.
The first quarter is complete.
Second quarter begins
Session 1: Red #2 tosses red team's 2nd ball.
All contestants including Red #2 place a wager.
Session 2: Black #2 tosses black team's 2nd ball.
All contestants including Black #2 place a wager.
Session 3: Blue #2 tosses blue team's 2nd ball.
All contestants including Blue #2 place a wager.
Session 4: Green #2 tosses green team's 2nd ball.
All contestants including Green #2 place a wager.

Once the second quarter is complete, it is halftime at which time all contestants still have 2 contracted balls but will have no wager chips. Hence they must each return to the assistant contractor to establish new contracts, following the same procedure as in the beginning of the game by selecting contract chips from their supply of colored contract wager chips, 8 of any value ranging from either a 1, 5, 10, or 20 on the face of the contract wager chip to be used as wagers. After selecting the wager chips the game continues, completing the last eight sessions in the same fashion as the first eight sessions. The third quarter begins with the legal member of the red team, red #1, acting as the designated shooter. Once the game participants contracts have been established and when everyone at the table has had a chance to place their wagers, the chief contractor using his handy remote, spins the contract wheel while announcing ‘no more wagers.’ Once he says this, at that moment no one is allowed to place or change their wagers. Then as the contract wheel spins, the chief contractor uses the contract remote to start the time clock to begin it's 5 second countdown, the designated shooter now launches one of his team's two remaining contracted balls towards the bull's-eye basket within the allotted 5 second time limit. The ball must land on the contract wheel and ultimately come to rest on one of the numbered slots of the contract wheel in order for the toss to be valid. A specially designed retaining wall (FIG. 7) is used for the purpose of keeping the ball in play. If the ball bounds out of the play area, outside the retaining wall, the shooter is given a second chance. However, if after the second attempt, should the said shooter's ball fail to land in play, the said shooter is to be disqualified for that toss and the said shooter must lose 200 points times the number on the face of the ball he tossed. The chief contractor will now take the disqualified shooter's ball, start the wheel again and drop the disqualified shooters ball onto the spinning wheel and where it lands will be the basis for determining payouts or loses for all the wagers that are currently on the contract wager boards. Only after the ball drops on a slot and the two contractors selects the winning numbers on the contract wager board, and clears all the losing wagers, after collecting debts for said losing wagers, then the process begins again with a new designated shooter. Bettors can then start placing new wagers while the two contractors pays the winners, collects debts from losers or makes change as necessary. The contract wheel has only 18 slots (FIG. 1) represented as follows: 10, 20, and 50 point slots, two of each on black and two of each on red, and two 100 point slots, one on black and one on red. For example the said numbers occupy spaces as such:
(2) 10 point slots on black at locations 22 and 15
(2) 20 point slots on black at locations 13 and 20
(2) 50 point slots on black at locations 18 and 29
(1) 100 point slot on black at location 27
(2)10 point slots on red at locations 14 and 23
(2) 20 point slots on red at locations 21 and 30
(2) 50 point slots on red at locations 19 and 28
(1)100 point slot on red at location 26
(2) lose 200 point slots which are yellow at locations 16 and 25
(2) bull's-eye slots worth 200 points which are green at locations 17 and 24 for a total of 18 slots (FIG. 1). The bull's-eye basket located at the center, (FIG. 2) is worth 200 points times the number on the face of the ball should a shooter make a basket when he tosses the said ball at the contract wheel. Shooters toss the contracted balls of values ranging from either a 1, 5, 10, or 20 (FIG. 3) at the bull's-eye basket, in an attempt to score the 200 points times the number on their contracted ball. For example a 10 ball accurately thrown into the bull's-eye basket would net the shooter 2000 points in point chips, 4000 or double if he actually wagered to make on the wager board (FIG. 4). Should same ball land on a black slot of any value that would net the shooter additional points, actually 10× the number the ball lands on. However should that same ball after passing thru the net, fall on the contract wheel only to end up on a red slot of any value this would cost the shooter valuable points, losing 10× the number the ball lands on, or the number on the ball times the number of the slot unless of course he bets on that red number. The shooter could also land on the loose 200 slot only to loose the 2000 point chips he just earned with the made shot. Ramification: Game could be played using dollars as the wages in which case the contract wheel and the wager board would have all the same numbers and colors, only dollar signs would appear in front of the numbers and contestants would be compensated dollar amount chips instead of point chips. see FIG. 5a,

### DRAWINGS

FIG. 1 contract wheel

FIG. 2 bull's eye basket

FIG. 3 contract balls

FIG. 4 contract wager chips

FIG. 5 contract point chips

FIG. 5a contract money chips

FIG. 6 contract wager board

FIG. 6a contract wager board

FIG. 7 contract chip sack.

FIG. 8 contract game with bull's eye basket, strobe lights, retaining wall and time clock

FIG. 9 contract remote

### DETAILED DESCRIPTION OF DRAWINGS

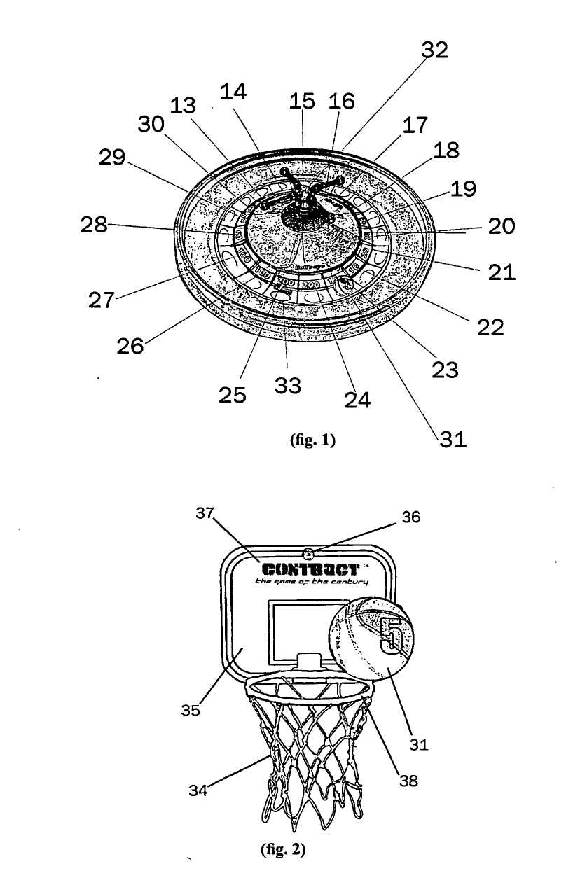

FIG. 1 Contract Wheel. This is no ordinary roulette wheel, this contract wheel has only 18 slots represented as follows: 10, 20, 50 and 100 point slots, two of each on black and two of each on red. For example the said numbers occupy spaces as such: (2) 10 point slots on black at locations 15 and 22, (2) 20 point slots on black, at locations 13 and 20 (2) 50 point slots on black at locations 18 and 29 (1) 100 point slot on black at location 27, (2) 10 point slots on red at locations 14 and 23, (2) 20 point slots on red at locations 21 and 30, (2) 50 point slots on red at locations 19 and 28, (1) 100 point slot on red at location 26, two lose 200 point slots which are yellow at locations 16 and 25, and (2) slots for the bull's-eye worth 200 points which are green, at locations 17 and 24 for a total of 18 slots. Each slot is fitted with a molded indenture at location 33, designed to fit the contract ball, at location 31, once it lands on the contract wheel. The four-armed agitator at location 32 is designed to make the landing of your shot more unpredictable as it hits your ball prior to it's landing on the wheel.

FIG. 2 bull's eye basket. A basket at location 38 with a net located at location 34, positioned at rear and center of the contract wheel attached to a backboard at location 35 containing the contract logo at location 37. This bull's eye basket will be attached to the back of the retaining wall to a wall mount that juts the basket into the center of the wheel of play and is secured there by a screw at location 36. Shooters can score 200 points times the number on the face of the ball at location 31 should they make the basket on the way to the contract wheel. Shooter can double their score by making a wager and landing on the wagered slot no matter what they wager. Shooters cannot lose points for missing the basket, unless they wagered on the wager board to make but then missed the shot. However the said shooter can also lose points if his ball lands on a red slot of any value or lands on the lose 200 slot, again, unless a wager was made to land on that exact red number or lose 200 yellow slot in which case the player wins the number on his wager chip times the number on the wagered red space or the wager chip number times 200 in the case of the yellow slot.

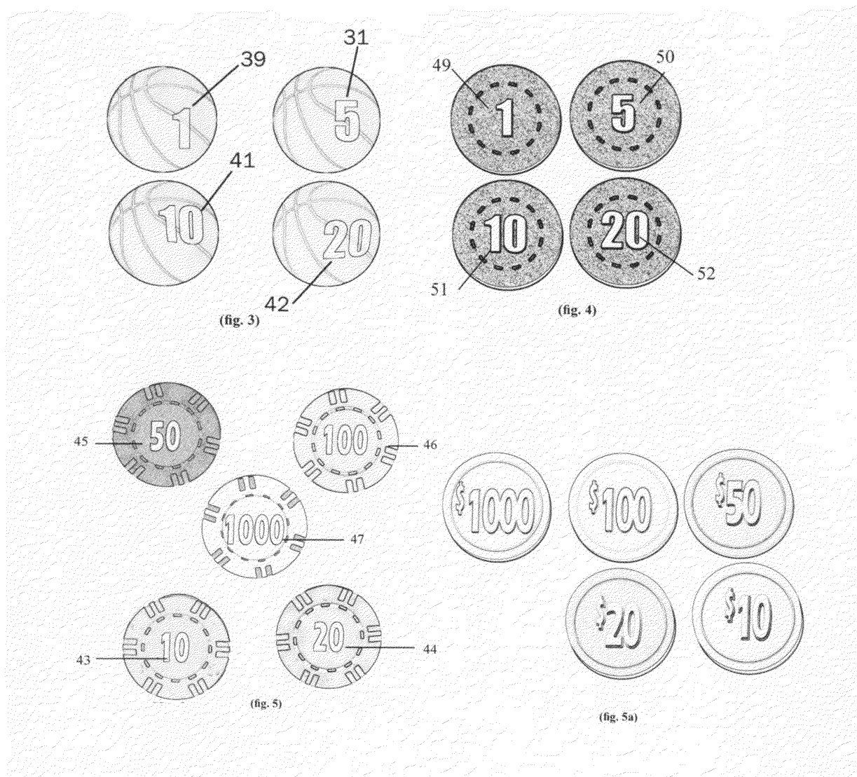

FIG. 3 contract balls. These balls, like the contract wager chips have either a 1 as at location 39, 5 as at location 40, 10 as at location 41, or 20 as at location 42 on the face and are used to make wagers on the play. They are colored: red, black, blue and green and each color represents a team. Teammates play only their own colored balls and use only their own colored wager chips to make bets. The ball, resembling a basketball, is roughly the size of a ping-pong ball but is made of firm rubber. The chief contractor and the designated shooter handle the ball per session. These balls remain with the chief contractor at all times and he removes them from the contract wheel at the end of each session of play.

FIG. 4 contract wager chip. These chips are solid in color, and like the balls have either a 1, 5, 10, or 20 on the face and are used to make wagers on the play. Unlike the point chips, however the contract chips have no point value and are not used to make payout but rather are used solely to make contract wagers. They are colored: red, black, blue and green and are linked with the teams of the same colors thus allowing the contractor to distinguish what team made the wager and thus speeding play along. The assistant contractor, the bettors and the shooter all handle the contract chips during each session, however, charge of these chips remain with the assistant contractor at all times and he alone removes them from the contract wager board at the end of each session of play.

FIG. 5 contract point chips: These differ in purpose as well as in appearance from the contract wager chips. Whereas the wager chips are solid in color, and represent a team, the point chips have white markings that give them a speckled look when stacked and are in no way associated with any particular team. Also, these point chips are used to pay out wagers and are not to be used to make wagers. The point values are as follows: red chips are worth 10 points each, black chips are worth 20 points each, blue chips are worth 100 points each, green chips are worth 50 points each, gold chips are worth 1000 points each. Each player on all four teams starts the game with the same amount of chips; 3000 points distributed in these values; 1 gold point chip (1000), 10 blue point chips, (1000), 10 green point chips (500), 20 black point chips (400) 10 red point chips (100). These 3000 points will be provided to all contestants in their very own team colored chip sack. Game can be played using cash values in place of points in which case all rules remain the same only chips look differently and have dollar signs on them. (see FIGS. 8 and 5a)

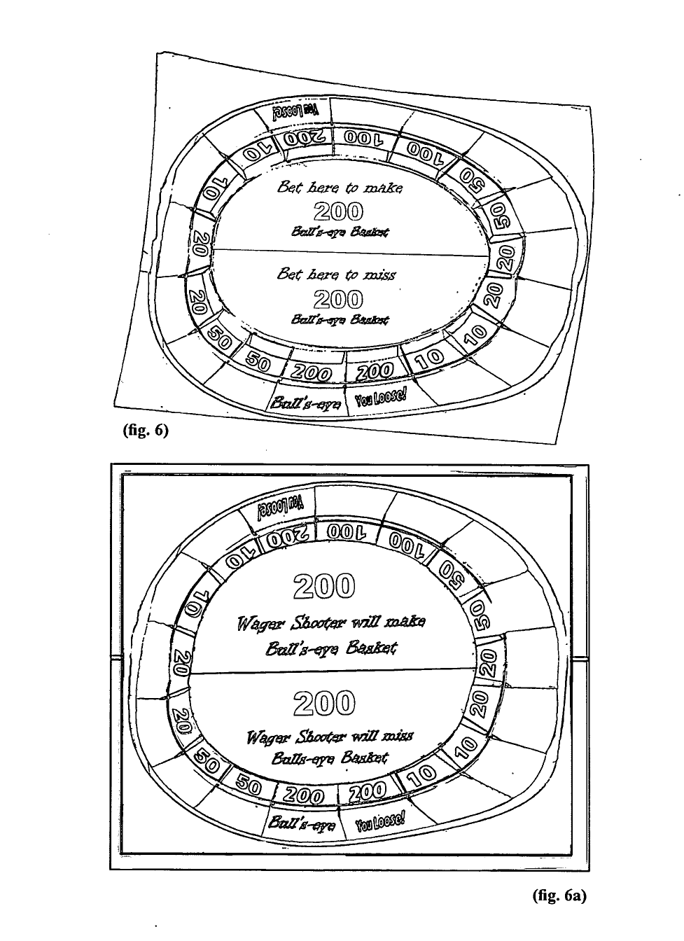

FIGS. 6 & 6a. the contract wager board. Every choice on the contract wheel has a corresponding selection represented on the wager board, For example the numbers occupy spaces as such: (2) 10 point spaces on black, (2) 20 point spaces on black, (2) 50 point spaces on black (1) 100 point space on black, (2) 10 point spaces on red, (2) 20 point spaces on red, (2) 50 point spaces on red, (1) 100 point space on red, (1) lose 200 point space which is yellow, (1) space for wagering that the shooter's tossed ball will land on the bull's-eye slot worth 200 points which is green and is identified by appearance as it looks like a slot on the wager board, (1) space to wager a shooter will miss his toss at the bull's-eye worth 200 points which is green, located in the right center half of the wager board and (1) space to wager the shooter will make his toss at the bull's-eye worth 200 points which is green, located in the left center half of the wager board for a total, of 19 spaces. The said designated shooter and all the bettors place wagers on any of the selections and by so doing either earn or loose point chips. The wager board could be a vinyl material, wood or metallic.

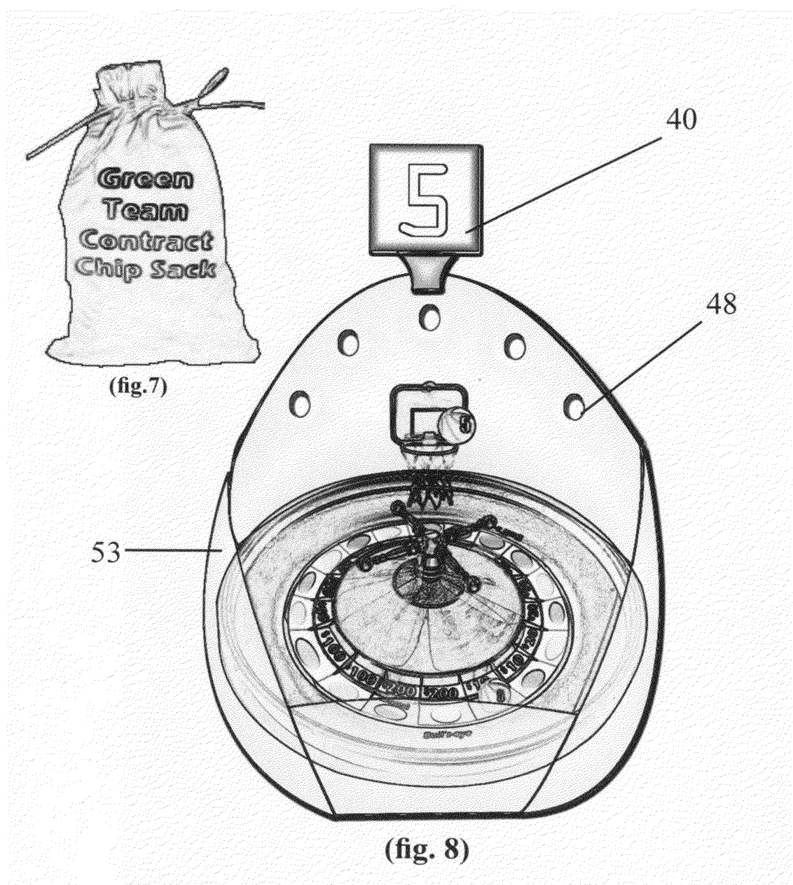

FIG. 7 the contract chip sack. Both teammates on all four teams get one of these drawstring bags at the start of the game. Each one's sack will contain 3000 points in chips to begin the game. Contestants will keep their chips in these sacks at all times unless they are making change, or paying one of the contractors for a lost bid. At the end of the game the teammates of the red and black teams will give their sacks containing all their chip earnings to the chief contractor to tally, while the teammates from the blue and green teams will give their sacks containing their said chip earnings to the assistant contractor to tally. Once all teams scores have been tallied a winning team is announced.

FIG. 8 Contract the game of the century features specially designed retaining wall used for the purpose of keeping the ball in play. The said wall is made of a see-thru material like plastic so that the ball is visible to contestants and onlookers at all times. The retaining wall has flashing strobe lights. These lights are built into the retaining wall, there are five of them and they flash in a strobe-like effect each time a shooter makes a basket. These lights are triggered by the contract remote which is in the possession of the chief contractor, he triggers the lights which are accompanied by bells, and he starts the time clock, also built into the retaining wall and is also activated by the contract remote at the command of the chief contractor at the beginning of each toss. The source of the power is plug in electric, however the game is also battery operated and have (4) 9 volt batteries housed in the base of the contract wheel. Such source powers:
(1) flashing strobe lights
(2) ringing bells
(3) personality voices
(4) time clock
(5) spinning contract wheel

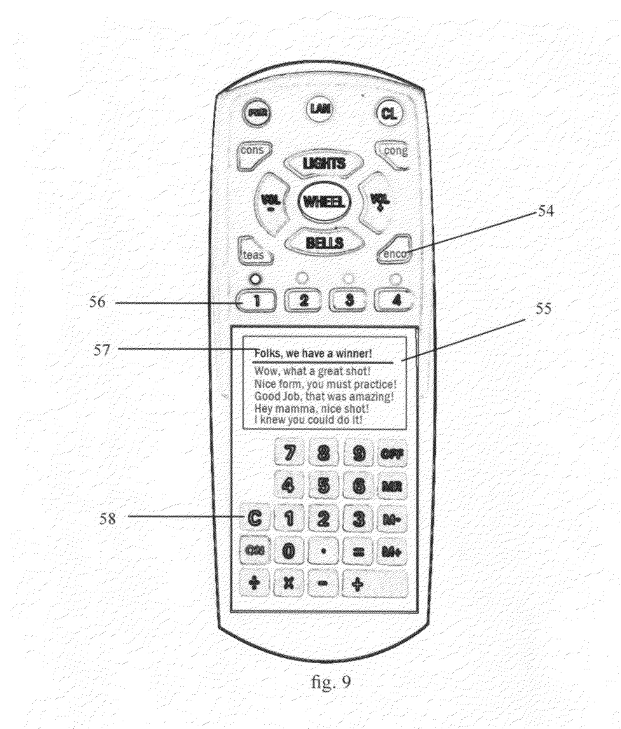

FIG. 9 the contract remote, used solely by the chief contractor. The said chief contractor uses the said remote to start the time clock, start the wheel, activate the flashing lights, when a attempt is negative he uses one of his programmed buttons to make an expression of disappointment in the case of a failed attempt or jubilation when an attempt is successful. The remote also serves as a calculator to assist in calculation of payouts and for tallying point chips at the end of the game to determine a winning team. The remote also features much more as described later in the section entitled “how to operate the remote”.

### REFERENCE NUMERALS

14 red 10 point slot
15 black 10 point slot
16 yellow lose 200 point slot
17 green bull's-eye 200 point slot
18 black 50 point slot
19 red 50 point slot
20 black 20 point slot
21 red 20 point slot
22 black 20 point slot
23 red 10 point slot
24 green bull's-eye 200 point slot
25 yellow lose 200 point slot
26 red 100 point slot
27 black 100 point slot
28 red 50 point slot
29 black 50 point slot
30 red 20 point slot
31 5×ball
32 contract wheel agitator
33 molded indenture, fits the contract ball once it lands on the contract wheel
34 net
35 backboard
36 screw
37 Contract logo
38 basket
39 1× ball
40 5 second clock
41 10× ball
42 20× ball
43 red speckled Contract 10 point chip
44 black speckled Contract 20 point chip
45 green speckled Contract 50 point chip
46 blue speckled Contract 100 point chip
47 gold speckled Contract 1000 point chip
48 strobe lights
49 1× point chip
50 5× point chip
51 10× point chip
52 20× point chip
53 retaining wall
54 encourage button, one of four programmable buttons
55 line in calculator window
56 programmable buttons 1-4
57 active phrase above the line
58 calculator on-off button

### OPERATION

The chief contractor, uses the battery operated contract remote to spin the contract wheel, activate the strobe lights, bells and personalities to make the game exciting. The said remote is also used by the chief contractor to aid in multiplying, adding and subtracting to keep the scoring accurate, said remote is also used for accurately calculating debts or earning made from wagers made on the wager board. The window of the calculator is used for programming when the cons, cong, teas, and enco buttons are individually pressed simultaneously with any of the programmable keys 1-4. Once the keys have been programmed and the red light goes out the window now displays the selection of phrases you have to choose from. Press the #1 button a listing of phrases appears in the window with one phrase appearing above the line in the calculator window while all other are below the said line. If you like the phase and want to hear it in the language and personality you pre-programmed, press the button again and that phrase and only that one above that line will play. Now double press the 1 button in quick succession, it plays the last message you played, and activates the lights, bells and applause all together. If you press and hold the 1 button it repeats that same last message over and over while activating the lights, bells and applause until you release it. If you want to go to another phrase use the scroll button to move the text up or down. If you chose not to program it has a default setting. Turn off the remote and turn it back on and it defaults to english, the remote then defaults to the last personalities entered into the remote. You don't even have to scroll thru the choices of expressions to choose one but you may choose instead to play the buttons blindly and be surprised along with everyone else at what the remote comes out with. At any time during the game should you need the calculator simply press the red on/off button located below the calculator window and the calculator functions will be available to you, when your are done with your calculations press the red on/off button again to turn off the calculator functions and the window goes right back to where you were prior to turning on the calculator. The remote is battery operated.

PWR—power button is the red button located in the upper left corner. Use it to turn on the remote. This button turns on the calculator for programming buttons only, the calculator has it's own red on/off button in the lower left corner and it should be used when you want to do calculations solely.

LAN—language button, located in the uppermost middle of the remote, allows you to program a personality from a choice of four different languages; english, spanish german or italian. English is the default language, however any number of languages can be programmed beyond even these at the discretion of the manufacturer.

CL—clock button is one of four blue buttons surrounding the wheel button, this button located just above the wheel button, starts the 5 second clock's count down.

Buttons 1 thru 4 are programmable, each has a variety of different expressions designed to induce applause and laughter from an onlooking crowd. If you press and hold the any of these buttons, 1-4, after these have been programmed, said buttons 1-4 will repeat the last expression played over and over and activates the lights, bells and applause until you release it.

cons—Console button located just below the pwr (power) offers expressions of consolation for a missed shot or a loss wager and is used to console game participants after something negative happens. It can be programmed in this way; press the cons button simultaneously with the lan button, and a choice of english, spanish german or italian will appear in the calculator window. Make sure your choice of said language is above the line and press the lan button alone. After selecting a language, next press the cons button simultaneously with the 1 button, a red light above the 1 turns on, and you'll see a selection of personalities such as maniacal, gnome, syfy. temptress, egor, valley girl, etc., appearing in the calculator window. Scroll through these and make sure the personality you want is above the line in the calculator window, then press and hold 1 button until it beeps and the red light goes of You have now programmed the 1 button to console in a language and personality of your choice. Defaulted into the remote are expressions like; “Ahhh, you were robbed!” or “Too bad, better luck next time!” or “Oops, you loose!” or “If it weren't for bad luck, you'd have no luck at all!” etc.

cong—Congratulate button located just below the CL or clock button is a collection of expressions of congratulations for a made shot or a winning wager and is used to cheer on game participants after something positive happens. It can be programmed in this way; press the cong button simultaneously with the lan button and a choice of english, spanish german or italian will appear in the calculator window. Select one and make sure your choice is above the line in the calculator window, then press the lan button alone. Now press the cong button simultaneously with the 2 button, a red light comes on above the 2 button and you'll see a selection of said personalities maniacal, gnome, syfy. temptress egor, valley girl, etc. appearing in the calculator window. Make sure the said personality selected is above the said line in the calculator window then press and hold 2 button until it beeps and the red light goes off. You have now programmed the 2 button to congratulate in a language and personality of your choice. Stored into the remote to be programmed are expressions like; “Folks, we have a winner!” or “Wow, what a great shot!” “That sir, was impressive!” etc.

teas—tease button located just below and left of the bells button is verbiage meant to poke fun at the player and generate laughs from the on lookers. Bystanders will be motivated to join in the first chance they get to be a part of the fun. The teas button can be programmed in this way; Press the teas button simultaneously with the lan button and a choice of english, spanish german or italian will appear in the calculator window. Select one, making sure your choice is above the line in the calculator window, press the lan button alone. Now Press the teas button simultaneously with the 3 button and a red light above the 3 button will turn on, at the same time you'll see a selection of personalities such as maniacal, gnome, syfy. temptress, egor, valley girl, etc., appearing in the calculator window. Make sure your choice is above the line in the calculator window and press and hold 3 button until you hear the beep and the light goes off. You have now programmed the 3 button to tease in a language and personality of your choice. Stored into the remote to be programmed are expressions like; “You throw like my sister!”, “What kind of shot was that?”, or “perhaps if we moved a little closer!” or “are you kidding me???” or “ I′d say, the form needs a little work! !” or “such skill!, such athleticism, such—okay, maybe a little luck!” or “ you should fire your mom as your shooting coach” etc.

Enco—Encourage button located just below and right of the bells button are expressions meant to spur on the player just prior to his shot or while the ball is on the spinning wheel or while anticipation is building as the ball spins round the contract wheel prior to settling on a slot. The enco button can be programmed in this way; Press the enco button simultaneously with the lan button and a choice of a choice of said languages will appear in the calculator window. Select one making sure your choice is above the line in the calculator window, and press the lan button alone. Now Press the enco button simultaneously with the 4 button and a red light will turn on above the 4 button, you'll see a selection of said personalities appearing in the calculator window. Make sure your choice is above the line in the calculator window and press and hold 4 button until it beeps and the red light goes off. You have now programmed the 4 button to encourage in a language and personality of your choice. Stored into the remote to be programmed are expressions like; “Relax, you can do it!”, “I feel a victory dance coming on!” or “Yes! Yes! Yes! Let's get ready to celebrate!” “I′ve never witnessed such skill!” or “You madam, are quite skilled!”

BELLS/LIGHTS—Lights button is one of four blue buttons surrounding the wheel button, this button located just above the wheel button activates the flashing strobe lights and the ringing bells simultaneously. Press it once and only the lights are activated but if you double press the button in quick secession, both the lights and the bells are activated. Same is so concerning the bells button located just below the wheel button; press it once and only the bells are activated, but if you double press the button in quick secession, both the lights and the bells are activated. No programming needed.

VOL+ and Vol− these two buttons situated opposite one another are used to control the volume and affects all sound related buttons by default when you lower or raise the volume, however to effect individual aspects for example first press the 1 button and let a personality speak and while the voice is speaking, lower or raise the volume to your liking. Because only the 1 button was activated the volume change will effect only that button. The Vol+ button is also used for scrolling up when used along with the program buttons 1-4 or for maneuvering text too long to read in the window to the left for readability. In the case when a line does not fit in the window because it's too long, use the volume+ to move the text to the left to continue reading. Use the− to move the text to the right. Don't worry should you go to the end and keep going you will simply make all lines move up one row or down one row depending on if you scroll right− or left+.

However, once the buttons have all been programmed and the light goes out under them, the Vol+ button defaults back to a volume increase button and the Vol− button used to scroll down returns to it's primary function of lowering the volume.

Bells—This button turns on the bell sounds. Press it once and only the bells sound but if you double press the button both the bells and the lights are activated simultaneously.

Wheel—This button activated the Contract wheel. Press it once while the wheel is motionless and it starts the wheel turning. If left alone the wheel on it's own would gradually come to a stop. However The Chief Contractor can begin to stop the wheel once the ball falls onto the contract wheel by simply double clicking the wheel button and this automatically causes the wheel to slow to a stop.

I claim:

1. A game comprising design, instructions and rules for:
a. An apparatus of claim 1 comprising a spinning wheel with slots and numbers used for making wagers.
b. An apparatus of claim claim 1 comprising a see-thru retaining wall for the purpose of keeping the ball in play.
c. An apparatus of claim claim 1 comprising a board having numbers numbers that occupy spaces as such: (2) 10 point spaces on black and on red, (2) 20 point spaces on black and on red, (2) 50 point spaces on black and on red, (1) 100 point space on black and on red, (1) lose 200 point space which is yellow, (1) space for wagering that the shooter's tossed ball will actually land on the bull's-eye slot worth 200 points which is green, (1) space to wager a shooter will miss his toss at the bull's-eye worth 200 points which is also green, located in the right center half of the wager board and (1) space to wager the shooter will make his toss at the bull's-eye worth 200 points which is green, located in the left center half of the wager board for a total of 19 spaces.
d. An apparatus claim 1 comprising a method to spin the wheel, activate the strobe lights, bells and personalities; used by the chief contractor to aid in multiplying, adding and subtracting, for calculating debts or earning made from wagers made, having programmable keys so as to have multiple personalities in several languages.

2. The instructions of claim 1 comprising a method of game play wherein game participants, up to ten, consisting of two contractors; the chief contractor, who handles the programmable contract remote, spins the contract wheel and handles the contracts and payouts for the game contestants, and collects debts from those making losing wagers.

3. The instructions of claim 1 comprising a method of game play wherein the assistant contractor, who handles the contracts and payouts for the game contestants and assist the chief contractor to control the play of the game.

4. The rules of claim 1 comprising a method of game play wherein teams are represented by colors; red, black, blue and green consisting of two teammates each.

5. The rules of claim 1 comprising a method of game play wherein said teams will risk points from a chip sack containing an allotment of points at games beginning.

6. The rules of claim 1 comprising a method of game play wherein said risk involves establishing contracts with both the said chief contractor and his assistant by selecting balls and wager chips with numbers on the face.

7. The rules of claim 1 comprising a method of game play wherein fulfillment of said contract involves the designated shooter from each team tossing his numbered ball at a bull's eye basket in an attempt to score 200 points times the number on the face of the ball, with the said ball ultimately to land on a spinning contract wheel to net the shooter additional points should he land on a black slot or loss of points, number on ball times number it lands on if ball lands on red.

8. The rules of claim 1 comprising a method of game play wherein said shooter must launch his ball at target before a buzzer sounds time, from a clock allowing 5 seconds,

9. The rules of claim 1 comprising a method of game play wherein participants from all teams place wager chips having a number on the face onto a wager board prior to the toss of the ball by the said designated shooter,

10. The rules of claim 1 comprising a method of game play wherein the winning team has the most combined point chips remaining at the end of four quarters.

11. An Apparatus of claim 2 wherein a remote is programmable to speak several languages and selected phrases.
a. serving as a calculator.
b. starting a contract wheel spinning around.
c. starting a time clock allowing seconds to toss a miniature basketball at a basket before a buzzer sounds.

12. The method of claim 11 comprising a method of game play wherein said tossed miniature basketball lands on a spinning contract wheel similar to a roulette wheel.

13. The method of claim 11 comprising a method of game play wherein apparatus of claim 11 has 18 slots; 10, 20, 50 point slots, two each on black and on red, two 100 point slots, one black, one red, two 200 points green bull's-eye slots, two yellow lose 200 point slots effecting scoring.

14. The method of claim 11 comprising a method of game play wherein said scoring is determined by number on said tossed basketball times number it settles on the contract wheel.
a. landing on black numbers would gain while landing on red would loose point chips.
b. scoring also determined by wagers made on a wager board times the number on the wager chip placed on said wager board.
